(19) United States
(12) Patent Application Publication
(10) Pub. No.: US 2018/0066823 A1
(43) Pub. Date: Mar. 8, 2018

(54) VEHICLE LAMP

(71) Applicant: Maxzone Auto Parts Corp., Fontana, CA (US)

(72) Inventor: Chung-Hsiao CHOU, Tainan City (TW)

(21) Appl. No.: 15/401,112

(22) Filed: Jan. 9, 2017

(30) Foreign Application Priority Data
Sep. 2, 2016 (TW) 105213558

(51) Int. Cl. F21S 8/10

(52) U.S. Cl. CPC F21S 48/1784; F21S 48/12; F21S 48/321; F21S 48/142; F21S 48/328; F21S 48/1317

(57) ABSTRACT

A vehicle lamp includes a lens, a light source, a reflector, a light deflection member and a light shielding member. The light source is for emitting a plurality of light beams. The reflector is for reflecting the light beams. The light deflection member includes a light deflecting surface, and a part of the light beams reflected by the light deflecting surface after reflecting by the reflector is emitted toward the lens. The light shielding member disposed between the light deflecting surface and the light source switches between a first position and a second position. Another part of the light beams is blocked by the light shielding member when the light shielding member is at the first position. The another part of the light beams is emitted toward the lens after reflecting by the reflector when the light shielding member is at the second position.

### RELATED APPLICATIONS

This application claims priority to Taiwan Application Serial Number 105213558, filed Sep. 2, 2016, which is herein incorporated by reference.

### BACKGROUND

### Technical Field

The present disclosure relates to an illuminating device. More particularly, the present disclosure relates to a vehicle lamp disposed at a vehicle for adjusting the light.

### Description of Related Art

Modern people care a lot about driving safety. In order to have good illumination in poor visibility conditions, conventional vehicles adapt lamp for providing lights in the night, the raining day or the dark time to increase the driving safety.

A vehicle lamp usually includes a switching function for changing high beam and low beam of the vehicle lamp. The conventional vehicle lamp includes two light sources and two reflecting surfaces disposed at a housing to emit high beam and low beam, respectively. Because using two light sources and two reflecting surfaces results in high cost, such kind of vehicle lamp is eliminated.

A new vehicle lamp with a single light source, a single reflecting surface and a switching mechanism is developed. The switching mechanism of the vehicle lamp includes a light shielding board and a driving unit. The light shielding board driven by the driving unit can block a part of the light emitting by the light source so as to change from the high beam to the low beam.

However, as the formulation of relevant safety regulations, the high beam pattern and low beam pattern along with the illuminance are formulated in the regulations. Hence, some practitioners improve the reflecting surface of the vehicle lamp and some practitioners improve the switching mechanism of the vehicle lamp so as to reduce the cost, to simplify the structure and to comply with regulation.

Therefore, how to develop a vehicle lamp which is complied with the regulation base on the ground of simplified structure and easy manufacture becomes a pursue target for the practitioners.

### SUMMARY

A vehicle lamp includes a lens, a light source, a reflector, a light deflection member and a light shielding member. The light source is disposed at one side of the lens for emitting a plurality of light beams. The reflector is for reflecting the light beams to emit the light beams toward the lens. The light deflection member is disposed between the lens and the light source. The light deflection member includes a light deflecting surface, and a part of the light beams which is reflected by the light deflecting surface after reflecting by the reflector is emitted toward the lens. The light shielding member is disposed between the light deflecting surface and the light source. The light shielding member switches between a first position and a second position. Another part of the light beams is blocked by the light shielding member when the light shielding member is at the first position. The another part of the light beams is emitted toward the lens after reflecting by the reflector when the light shielding member is at the second position.

### BRIEF DESCRIPTION OF THE DRAWINGS

The disclosure can be more fully understood by reading the following detailed description of the embodiments, with reference made to the accompanying drawings as follows:

FIG. 1 shows a three dimensional view of a vehicle lamp according to one embodiment of the present disclosure;

FIG. 2 shows an exploded view of the vehicle lamp of FIG. 1;

FIG. 3A shows a sectional view of the vehicle lamp of FIG. 1;

FIG. 3B shows another sectional view of the vehicle lamp of FIG. 1;

FIG. 4 show a schematic view of a combination state of a light deflection member, a light shielding member and a driving member of FIG. 1; and

FIG. 5 show a schematic view of an exploded state of the light deflection member, the light shielding member and the driving member of FIG. 1.

### DETAILED DESCRIPTION

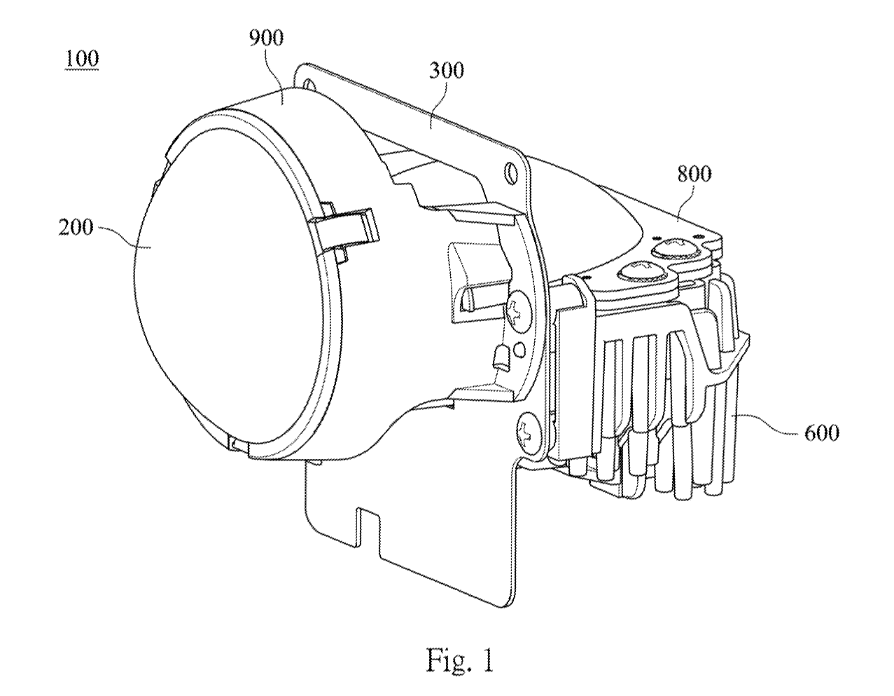

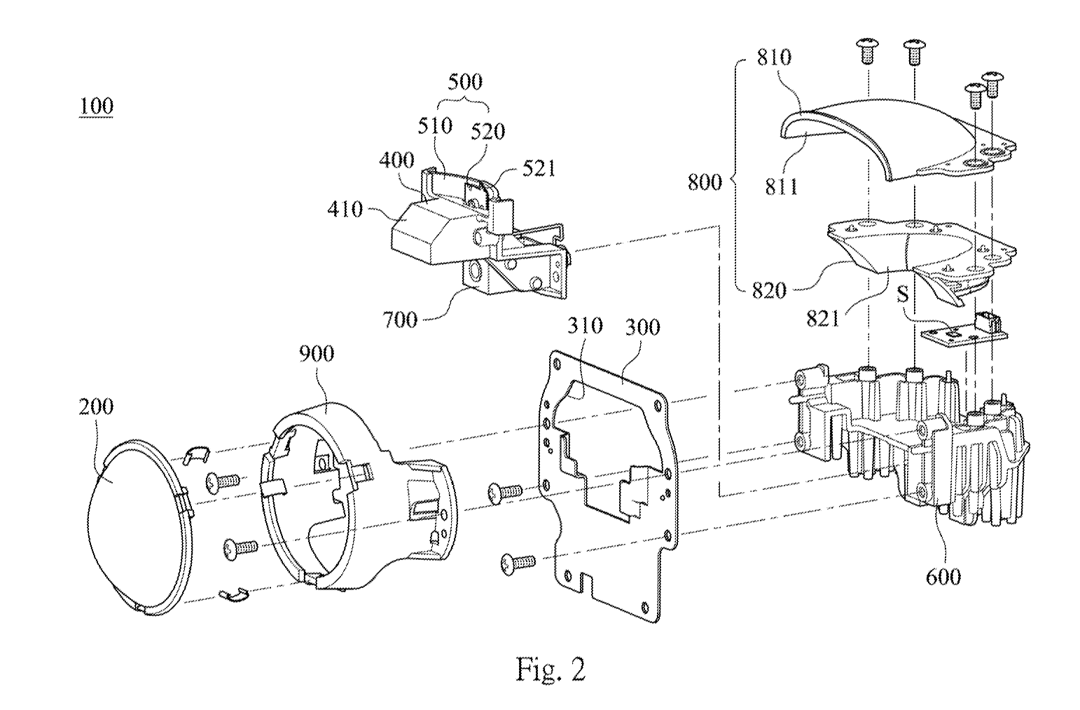

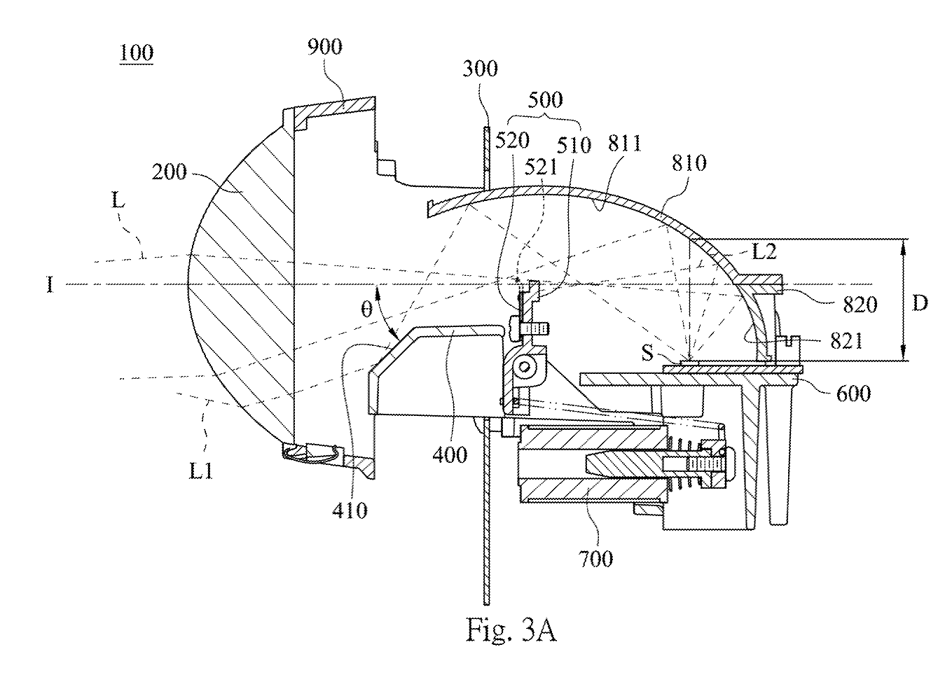

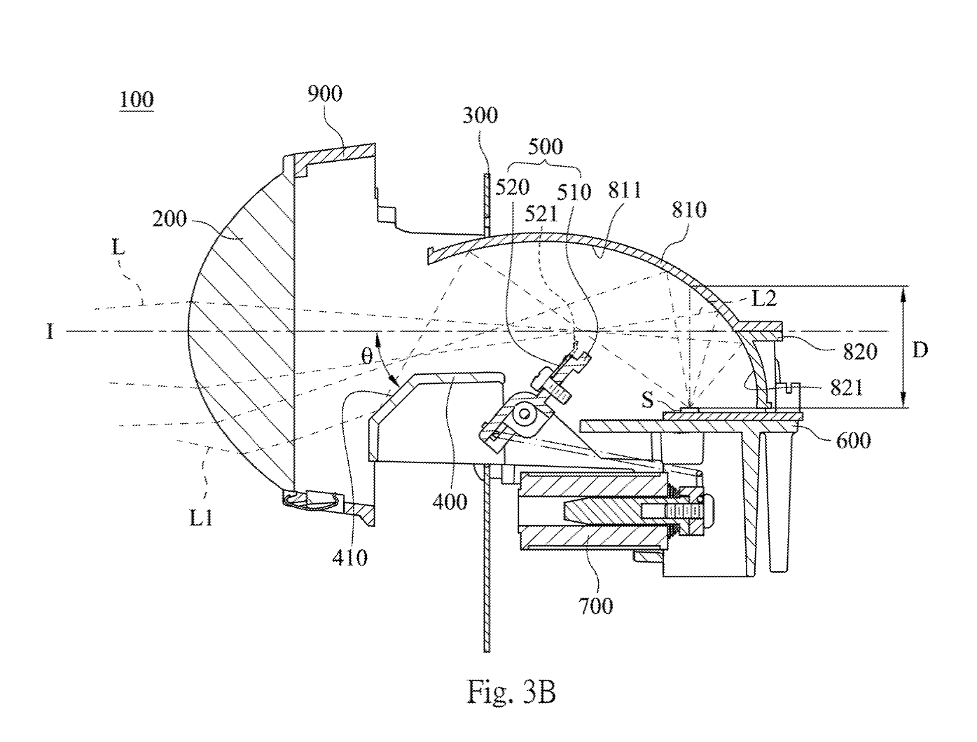

Please refer to FIG. 1, FIG. 2, FIG. 3A and FIG. 3B. FIG. 1 shows a three dimensional view of a vehicle lamp 100 according to one embodiment of the present disclosure. FIG. 2 shows an exploded view of the vehicle lamp 100 of FIG. 1. FIG. 3A shows a sectional view of the vehicle lamp 100 of FIG. 1. FIG. 3B shows another sectional view of the vehicle lamp 100 of FIG. 1. The vehicle lamp 100 includes a lens 200, a light source S, a reflector 800, a light deflection member 400 and a light shielding member 500.

The light source S is disposed at one side of the lens 200 for emitting a plurality of light beams L. The reflector 800 configures for reflecting the light beams L to emit the light beams L toward the lens 200.

The light deflection member 400 is disposed between the lens 200 and the light source S. The light deflection member 400 includes a light deflecting surface 410, and a part of the light beams (marked as L1 in FIG. 3A) which is reflected by the light deflecting surface 410 after reflecting by the reflector 800 is emitted toward the lens 200.

The light shielding member 500 is disposed between the light deflection member 400 and the light source S. The light shielding member 500 switches between a first position and a second position relative to the light source S. Another part of the light beams (marked as 12 in FIG. 3A) is blocked by the light shielding member 500 when the light shielding member 500 is at the first position. The another part of the light beams L2 is emitted toward the lens 200 after reflecting by the reflector 800 when the light shielding member 500 is at the second position.

Therefore, the light deflecting surface 410 of the light deflection member 400 can emit the light beams L1 which cannot be used in the conventional vehicle lamp toward the lens 200 so as to project the light beams L1 to an insufficient place of the low beam pattern. The detail structure and operation of the vehicle lamp 100 will be described in the following paragraphs.

The vehicle lamp 100 further includes a frame 900, a lamp frame 300 and a heat sink 600. The lens 200 is fixed at the frame 900. The frame 900 is abutted against the lamp fame 300. Both the frame 900 and the lamp frame 300 are secured to the heat sink 600. The light source S is disposed at the heat sink 600 so that the heat sink 600 can assist in the heat radiation. The lamp frame 300 includes an opening 310. The light deflection member 400 is disposed at the heat sink 600 and one end of the light deflection member 400 is protruded out of the opening 310 toward the lens 200. The light shielding member 500 is pivotally disposed at the light deflection member 400 so that the light shielding member 500 can switch between the first position and the second position relative to the light source S, as shown in FIGS. 3A and 3B.

To be more specific, the light deflection member 400 is a polyhedron frame. The light deflecting surface 410 is disposed at the end of a main body of the light deflection member 400, which is protruded out of the opening 310. The lens 200 has an optical axis I, and an angle θ contained between the light deflecting surface 410 and the optical axis I is smaller than 90 degrees; that is, the light deflecting surface 410 is not perpendicular to the optical axis I. Hence, the light beams L1 can be reflected by the light deflecting surface 410 to emit toward the lens 200.

As shown in FIG. 3A, the light shielding member 500 is at the first position and is substantially perpendicular to the optical axis I. The light beams L2 is blocked by the light shielding member 500 and cannot emit toward the lens 200; thus, the vehicle lamp 100 projects a low beam pattern. Because the light deflecting surface 410 can reflect the light beams L1 which cannot be used in the conventional vehicle lamp toward the lens 200, the insufficient space of the low beam pattern projected by the vehicle lamp 100 is lightened and can comply with the regulations.

As shown in FIG. 3B, the light shielding member 500 switches to the second position. The light beams L2 which is blocked by the light shielding member 500 when the light shielding member 500 is at the first position is no longer blocked by the light shielding member 500 and can be reflected by the reflector 800 to emit toward the lens 200; thus, the vehicle lamp 100 projects a high beam pattern. Although the light deflecting surface 410 still reflects the light beams L1 so as to emit the light beams L1 toward the lens 200 at the same time, the high beam pattern or illuminance of the high beam will not be affected due to high illuminance of the high beam.

The reflector 800 is covered on the light source S. The reflector 800 includes a first reflecting surface 811 facing toward the light source S, and a smallest perpendicular distance D contained between the light source S and the first reflecting surface 811 is larger than 20 mm. Precisely, the reflector 800 includes a first reflecting portion 810 and a second reflecting portion 820. The first reflecting portion 810 includes a first reflecting surface 811 and the second reflecting portion 820 which is disposed at the heat sink 600 is connected to the first reflecting portion 810. The second reflecting portion 820 includes a second reflecting surface 821 facing toward the light source S and the second reflecting surface 821 is connected to the first reflecting surface 811 to form an arc surface (not labeled). In addition, a connecting part between the first reflecting surface 811 and the second reflecting surface 821 is at the optical axis I.

With the configuration of the first reflecting portion 810 and the second reflection portion 820, it is easy to make a suitable surface shape when manufacturing the reflector 800 so that the light beams L reflected by the first reflecting surface 811 and the second reflecting surface 821 can emit the lens 200 with suitable angles. Preferably, the smallest perpendicular distance D is larger than 20 mm.

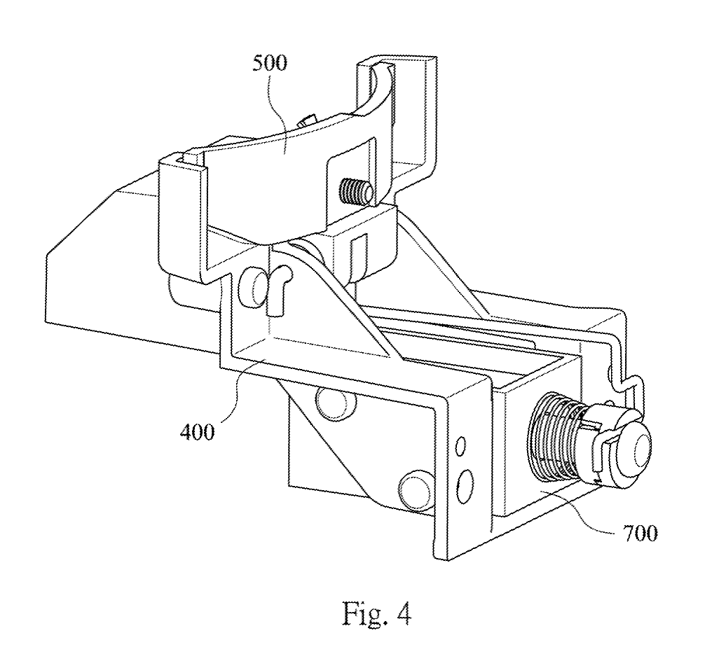

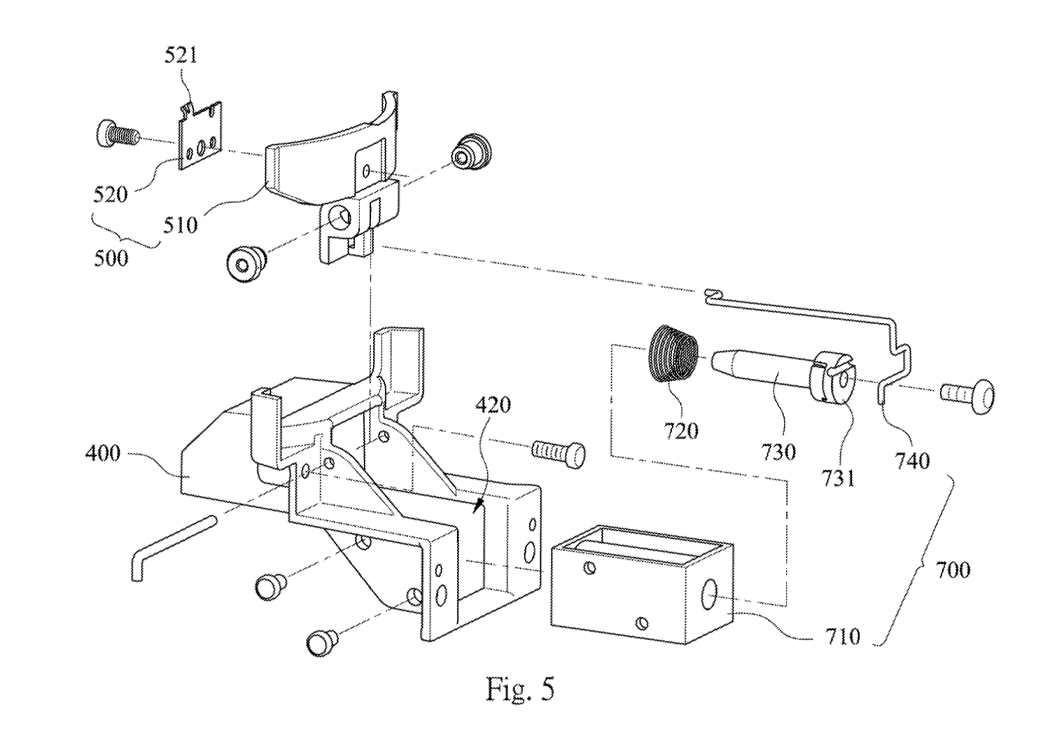

Please refer to FIG. 4 and FIG. 5. FIG. 4 show a schematic view of a combination state of a light deflection member 400, a light shielding member 500 and a driving member 700 of FIG. 1 and FIG. 5 show a schematic view of an exploded state of the light deflection member 400, the light shielding member 500 and the driving member 700 of FIG. 1. Because the light deflection member 400 is a polyhedron frame, a receiving space 420 formed therein is for disposing the driving member 700. The driving member 700 includes a solenoid valve main body 710, a spring 720, a plunger 730 and a linking rod 740. The plunger 730 is disposed in the solenoid valve main body 710 and includes a disposing end 731 exposed to an outside of the solenoid valve main body 710. The spring 720 is sleeved on the plunger 730 and both ends of the spring 720 abut between the disposing end 731 and the solenoid valve main body 710, respectively. One end of the linking rod 740 is disposed at the disposing end 731, and the other end of the linking rod 740 is connected to the light shielding member 500.

The plunger 730 will move when the solenoid valve main body 710 is electrified, and the linking rod 740 is moved so as to move the light shielding member 500. When the solenoid valve main body 710 is not electrified, the plunger 730 linking with the linking rod 740 goes back to the original position due to the resilience of the spring 720 so as to move the light shielding member 500. Moreover, because the light shielding member 500 is pivotally disposed at the light deflection member 400, the operation of the driving member 700 can switch the light shielding member 500 between the first position and the second position relative to the light source S.

Please refer to FIG. 2, FIG. 3A and FIG. 3B. The light shielding member 500 includes a first light shielding board 510 and a second light shielding board 520. The second light shielding board 520 is disposed at the first light shielding board 510 and includes a protruding portion 521. The protruding portion 521 is protruded from the first light shielding board 510. When the light shielding member 500 is at the first position, the protruding portion 521 can block a part of the light beams L to prevent a specific part of the light pattern, which corresponds to the lane, from being too bright. In addition, whole illuminance of the light pattern projected by the vehicle lamp 100 can comply with the requirement of the regulation.

Base on the above description, the vehicle lamp 100 has several advantages.

1. With the light deflection member, the light beams which cannot be used in the conventional vehicle lamp can be used; therefore, the insufficient place of the low beam pattern can be compensated so as to comply with the regulation.

2. If the light deflection member is a polyhedron frame and is for disposing the driving member, the structure thereof can be simplified and a goal of easy manufacturing can be achieved.

3. If the light shielding member includes a first light shielding board and a second light shielding board, and the second light shielding board includes a protruding portion protruded from the first light shielding board, the light pattern of the vehicle lamp, which corresponds to the lane, will not be over-bright.

4. With the first reflecting portion, the second reflecting portion, the first reflecting surface contained by the first reflecting portion and the second reflecting surface contained by the second reflecting portion, it is easy to make a suitable surface shape when manufacturing the reflector.

5. With the structure of the vehicle lamp of the present disclosure, the size of the light deflection member, the light shielding member and the driving member can be reduced so as to be applied to different vehicle lamps with different size.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A vehicle lamp, comprising:
a lens;
a light source disposed at one side of the lens for emitting a plurality of light beams;
a reflector for reflecting the light beams to emit the light beams toward the lens;
a light deflection member disposed between the lens and the light source, the light deflection member comprising a light deflecting surface, a part of the light beams which is reflected by the light deflecting surface after reflecting by the reflector being emitted toward the lens; and
a light shielding member disposed between the light deflecting surface and the light source, the light shielding member switching between a first position and a second position relative to the light source, another part of the light beams being blocked by the light shielding member when the light shielding member being at the first position, and the another part of the light beams being emitted toward the lens after reflecting by the reflector when the light shielding member being at the second position.

2. The vehicle lamp of claim 1, wherein the reflector is covered on the light source, and the reflector comprise:
a first reflecting surface facing toward the light source;
wherein a smallest perpendicular distance is contained between the light source and the first reflecting surface, the smallest perpendicular distance is larger than 20 mm.

3. The vehicle lamp of claim 2, further comprising:
a heat sink connecting to the light source for heat dissipation;
wherein the heat sink is for disposing the reflector.

4. The vehicle lamp of claim 3, wherein the reflector further comprise:
a first reflecting portion, comprising the first reflecting surface; and
a second reflecting portion connecting to the first reflecting portion being disposed at the heat sink, the second reflecting portion comprising a second reflecting surface facing toward the light source, wherein the second reflecting surface is connected to the first reflecting surface to form an arc surface.

5. The vehicle lamp of claim 4, wherein the lens has an optical axis, and a connecting part between the first reflecting surface and the second reflecting surface is at the optical axis.

6. The vehicle lamp of claim 3, wherein the light deflection member is disposed at the heat sink.

7. The vehicle lamp of claim 1, wherein the light deflection member is a polyhedron frame.

8. The vehicle lamp of claim 1, wherein an angle is contained between the light deflecting surface and an optical axis of the lens, and the angle is less than 90 degree.

9. The vehicle lamp of claim 1, wherein the light shielding member comprises:
a first light shielding board; and
a second light shielding board disposed at the first light shielding board, the second light shielding board comprising a protruding portion protruding from the first light shielding board.

10. The vehicle lamp of claim 1, wherein the light shielding member is connected to the light deflection member.
